(19) United States
(12) Patent Application Publication
(10) Pub. No.: US 2004/0108057 A1
(43) Pub. Date: Jun. 10, 2004

(54) Method of manufacturing airtight container and method of manufacturing image display apparatus

(75) Inventors: Masaki Tokioka, Kanagawa (JP); Hiroharu Ueda, Kanagawa (JP); Mitsutoshi Hasegawa, Kanagawa (JP); Kazuo Koyanagi, Kanagawa (JP); Tokutaka Miura, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/724,605

(22) Filed: Dec. 2, 2003

(30) Foreign Application Priority Data
Dec. 6, 2002 (JP) 2002-355317
Oct. 24, 2003 (JP) 2003-363986

(51) Int. Cl. B32B 31/00

(52) U.S. Cl. 156/292; 156/309.6

(57) ABSTRACT

The present invention relates to a method of manufacturing an airtight container and a method of manufacturing an image display apparatus. In particular, the invention discloses a method of manufacturing an airtight container, including the steps of: setting a member for defining an airtight space together with a substrate to abut on the substrate; supplying a seal bonding material to a corner portion formed by the substrate and the member or a portion to be the corner portion formed in the setting step; and forming a closed bonding line by performing airtight bonding of each of the substrate and the member with the seal bonding material by locally heating the seal bonding material to a temperature equal to or higher than a temperature that allows the airtight bonding and then curing the seal bonding material.

### BACKGROUND OF THE INVENTION

1. Field of the Invention

The present invention relates to a method of manufacturing an airtight container. Also, the invention relates to a method of manufacturing an airtight container having a high airtightness which is suitable for use in an image display apparatus. Also, the invention relates to a method of manufacturing an image display apparatus.

2. Related Background Art

Examples of prior art techniques relating to air tight containers used in plane type image-forming apparatuses include those disclosed in JP 2001-210258 A, JP 2000-251654 A, JP 2001-229828 A.

JP 2001-210258 A discloses an image display apparatus having a vacuum envelope.. In particular, JP 2001-210258 A discloses a technique for seal bonding a substrate and a side wall by means of a low-melting metal material within a vacuum chamber.

JP 2000-251654 A discloses, as an invention relating to an airtight container, “an airtight container composed of a pair of panels facing each other, support members for supporting the distance between the panels, and airtight sealing parts for maintaining the airtight condition between the panels, in which the airtight sealing parts are seal bonded with a low-melting metal”. In particular, JP 2000-251654 A discloses a structure in which the airtight sealing parts are formed of metal members, and after overlapping a rear plate and a face plate, which are each provided with the metal members, while aligning those plates relative to each other, bonding parts of the metal members are successively bonded together with the low-melting metal by using a triaxial soldering robot, thereby effecting seal bonding of the container.

Further, JP 2001-229828 A discloses an invention relating to a method of manufacturing an image display apparatus, the method including “a step of heat seal bonding a first base plate and a second base plate in a state where they are opposed to each other, by bringing, under a vacuum atmosphere, the first and second base plates into a seal bonding treatment chamber having a vacuum atmosphere, in which a low-melting substance is used as a seal bonding material used for the seal bonding step”. The method disclosed realizes significant reductions in the number of steps and time required for manufacturing the image display apparatus.

Note that JP 2001-210258 A corresponds to U.S. 2002180342 B and JP 2001-229828 A corresponds to U.S. 2,001034175 B.

### SUMMARY OF THE INVENTION

An object of the present invention is to attain a novel technique for manufacturing an airtight container easily and with good yield.

According to a first aspect of the present invention, there is provided a method of manufacturing an airtight container, including the steps of: setting a member for defining an airtight space together with a substrate to abut on the substrate; supplying a seal bonding material to a corner portion formed by the substrate and the member or a portion to be the corner portion by formed in the setting step; and, after the step of setting the member to abut on the substrate, forming a closed bonding line by performing airtight bonding of each of the substrate and the member with the seal bonding material by locally heating the seal bonding material to a temperature equal to or higher than a temperature that allows the airtight bonding and then curing the seal bonding material.

In the case of local heating, a temperature at the position where heating has been performed can be rapidly lowered by stopping the heating, changing the heating position, etc. In order to achieve a rapid decrease in temperature, the local heating is desirably performed under a condition which ensures that, in the vicinity of the position subject to local heating to reach a temperature equal to or higher than a temperature that enables bonding, the temperature becomes lower than the temperature that enables bonding. Note that the temperature that enables bonding refers to a temperature at which at least bonding becomes possible under an environment for performing the bonding step. For instance, when metal is used as the seal bonding material, bonding becomes possible if the metal has been melted; therefore, if a temperature equal to or above the melting temperature of the metal is reached, it can be said that the seal bonding material has been heated to a temperature equal to or above a temperature that enables seal bonding. As a construction for locally heating the seal bonding material to a temperature equal to or above the temperature that enables seal bonding, a predetermined heating means for performing local heating and, for example, another heating means capable of effecting a temperature elevation over a wider area and in a more uniform fashion as compared with the temperature elevation effected by the predetermined heating means are used in combination, so that heating by the predetermined heating means and heating by another heating means mentioned above may be used in combination to heat the seal bonding material to the temperature equal to or above the temperature that allows seal bonding. At positions where the amount of temperature elevation by the predetermined heating means is smaller than that for the seal bonding material, rapid cooling can be achieved due to the temperature being lower at those positions than the temperature that enables bonding of the seal bonding material.

Note that, if, in the step of supplying the seal bonding material to the corner portion formed by the substrate and the member or a portion to be the corner portion formed in the setting step, the seal bonding material is supplied to the corner portion formed by the substrate and the member, the step is performed after the setting step, whereas if the seal bonding material is supplied to the portion to be the corner portion formed in the setting step, the seal bonding step is performed prior to the setting step. However, by adopting a construction in which the seal bonding material is supplied after forming the corner portion, a supply position can be determined easily when supplying the seal bonding material; thus, it is particularly desirable to adopt the construction in which the seal bonding material is supplied after defining the corner portion.

As the substrates used herein, various types of substrates may be used. Preferred examples of substrates that may be used include: a glass board; a board having a predetermined film such as an insulating film coating over its base; and a board having a predetermined member such as wiring formed on its base. When using a substrate having the predetermined film or the predetermined member formed on its base, in the step of bringing the member for defining the airtight space into abutment on the substrate, the member for defining the airtight space may be abutted on the predetermined film or the predetermined member.

By performing the step of locally heating the seal bonding material to a temperature that allows bonding or higher after the step of supplying the seal bonding material, it is possible to increase the degree of freedom regarding the supplying mode of the seal bonding material. This arrangement is particularly preferable because it allows use of a seal bonding material that is molded into a solid state. However, as described below, in another aspect of the present invention, the invention also includes a construction in which bonding is performed by supplying the seal bonding material that has been heated to a temperature equal to or higher than a temperature that enables the bonding.

That is, according to a second aspect of the present invention, there is provided a method of manufacturing an airtight container, including the steps of: setting a member for defining an airtight space together with a substrate to abut on the substrate; and, after the step of setting the member to abut on the member, forming a closed bonding line by performing airtight bonding of each of the substrate and the member with a seal bonding material by supplying, to a corner portion formed by the substrate and the member, the seal bonding material that is heated to a temperature equal to or higher than a temperature that allows the airtight bonding and then curing the seal bonding material.

In each of the above-described aspects of the invention, a construction may be suitably adopted in which the closed bonding line is formed by performing the bonding for each small region at a time. The above-mentioned operation of forming the closed bonding line by performing the bonding for each small region at a time refers to forming the closed bonding line part by part. Cases where the bonding is performed for each small region at a time includes a case where the bonding is performed while continuously changing the location that is subject to bonding. Further, although a construction may be suitably adopted in which the small region subject to bonding is successively changed along the position where the bonding line to be formed, the present invention is not limited to this construction.

Note that, in each of the above-described aspects of the invention, it is preferable to perform the bonding step under a vacuum atmosphere. Also, the abutting step is desirably performed under a vacuum atmosphere. A vacuum atmosphere refers to an atmosphere under a reduced pressure as compared with an ambient atmosphere. When manufacturing an airtight container having electron-emitting devices arranged in its interior, the vacuum atmosphere employed is desirably an atmosphere under a pressure of not higher than 10⁻³ Pa. Further, when manufacturing an airtight container filled with a desired gas, it is desirable to perform the bonding step or the abutting step under an atmosphere containing the gas.

Further, in each of the above-described aspects of the invention, there may suitably adopted a construction in which the seal bonding material is melted by means of the local heating means while being dispensed from a seal bonding material supplying means, or a construction in which the melted seal bonding material is dispensed from the local heating means to be supplied to the corner portion.

Further, a construction may be suitably adopted in which the bonding step is performed while vibration is given to the seal bonding material. In addition, a photoirradiation means may be suitably employed as the local heating means.

Further, the seal bonding material is preferably a low-melting substance. The term “low-melting substance” as used herein refers to a substance having a melting or softening point of not higher than 300° C. Generally speaking, when used under a high-temperature environment, glass, which is typically employed as the material of an airtight container, is susceptible to dispersion of metal atoms, particularly silver or copper. Such dispersion of metal atoms, as it proceeds, may considerably impair the performance of electronic devices that have been formed or will be formed inside the container. It is known that, particularly at high temperatures exceeding 300° C., the dispersion occurs in proportion to time. Therefore, solder materials such as metal In or its alloys, or PbSn, may be given as examples of substances satisfying the above-mentioned condition.

Further, it is preferable to form a groove portion in the corner portion in a state where the abutting step is performed, the groove portion being shaped so as to enable seal bonding to be performed in a favorable manner using the seal bonding material. The formation of the groove portion is preferably performed prior to the abutting step.

Further, a construction may be suitably adopted in which a material exhibiting a good wettability with the seal bonding material is formed as a base film in a location where the seal bonding material is to be arranged. “A material exhibiting a good wettability with the seal bonding material” refers to such a material that the wettability between the seal bonding material and the base film made of this material is superior to the wettability between the seal bonding material and a surface on which the seal bonding material is to be arranged in the case where the seal bonding material is arranged without forming the base film made of this material. A construction may also be suitably adopted in which the seal bonding material is heat-melted indirectly by heating the base film.

In addition, a construction may be suitably adopted in which cooled and cured bond-sealing material is covered with a reinforcing material.

Particularly preferred is a construction in which, when the seal bonding member, which is obtained as the seal bonding material solidifies at a predetermined position of the bonding line, is seen in cross section taken along a direction perpendicular to the longitudinal direction of the bonding line, in the corner portion formed by the substrate and the above-mentioned member by abutting the member and the substrate, a penetration length of the seal bonding member penetrating between the mutually opposed surfaces of the substrate and the above-mentioned member is shorter than a contact length over which the seal bonding member contacts the above-mentioned member. It is particularly preferred that the above-mentioned penetration length is 0 such as described in after mentioned preferred embodiments. The above-described arrangement is illustrated in FIGS. 10A and 10B. In FIGS. 10A and 10B, the seal bonding material penetrates between the mutually parallel opposing surfaces of the substrate 2 and the member 3 and solidifies therein. The penetration length is expressed as Q2, and the contact length between the member 3 and the seal bonding material is expressed as Q1. It is preferable that Q1>Q2, and it is particularly preferable that Q2 is 0. This can be achieved by performing the step of supplying the seal bonding material under such conditions that allow Q1>Q2 to be attained with the seal bonding member that will be formed due to the subsequent solidification of the seal bonding material. More specifically, this can be achieved by controlling the amount of the seal bonding material to be supplied. It is also possible to achieve Q1>Q2 by controlling the pressure with which the substrate and the member are abutted against each other. FIG. 10 shows emphatically convex and concave of the mutually parallel opposing surfaces of the substrate 2 and the member 3.

Further, the present invention also relates to a method of manufacturing an image display apparatus, the method being characterized by including forming an airtight container for containing display devices by using the airtight container manufacturing method described hereinabove. Suitable examples of the display devices include electron-emitting devices such as a surface conduction electron-emitting device, electroluminescence devices, and the like.

### BRIEF DESCRIPTION OF THE DRAWINGS

FIGS. 1A, 1B, 1C, and 1D are explanatory diagrams showing a method of manufacturing an airtight container according to Embodiment 1 of the present invention;

FIG. 2 is an enlarged explanatory diagram showing a seal bonding portion in the method of manufacturing an airtight container according to Embodiment 1;

FIG. 3 is an enlarged explanatory diagram showing a state in which a base film has been formed in the method of manufacturing an airtight container according to Embodiment 1;

FIGS. 4A, 4B, 4C, and 4D are explanatory diagrams showing a method of manufacturing an airtight container according to Embodiment 2 of the present invention;

FIG. 5 is a diagram for explaining a local heating step according to Embodiment 2 of the present invention;

FIG. 6 is an enlarged explanatory diagram showing a state in which a groove portion has been formed according to Embodiment 2;

FIGS. 7A, 7B, 7C, and 7D are explanatory diagrams showing a method of manufacturing an airtight container according to Embodiment 3 of the present invention;

FIGS. 8A, 8B, 8C, and 8D are explanatory diagrams showing a method of manufacturing an airtight container according to Embodiment 4 of the present invention;

FIG. 9 is a diagram showing a construction of an image display apparatus; and

FIGS. 10A and 10B are cross-sectional views of a seal bonding member taken at a predetermined position of a bonding line.

### DESCRIPTION OF THE PREFERRED EMBODIMENTS

One advantage of utilizing local heating is that the heated location can be quickly cooled upon finishing the heating. This advantage can be exploited also in the case where bulk heating of up to a temperature equal to or lower than a temperature capable of effecting seal bonding, and the local heating are used in combination. This advantage becomes particularly remarkable when the local heating is performed for a small region at a time to successively form a bonding line. However, the above-described advantage of enabling rapid cooling can actually cause an inconvenience in some applications. For example, as described in Patent Document 1, when adopting a construction in which a seal bonding material is melted and cured in a gap between two members, the seal bonding conditions need to be determined by taking into consideration both the degree of fluidization and the curing rate of the seal bonding material. That is, while fluidity needs to be maintained for some time period for sealing the gap with the seal bonding material, a location where heating has ceased as the target position for heating is changed and the location becomes outside the target heating position, is rapidly cooled. Therefore, for example, it is necessary to move the heating unit slowly enough to maintain the fluidity for a requisite period of time. However, an excessively long heating period results in excessive fluidization of the seal bonding material, making it impossible to ensure a sufficient contact between the seal bonding material and each of the upper and lower surfaces subject to seal bonding, particularly the upper surface. Therefore, when local heating is employed to achieve the construction in which the seal bonding material is arranged in the gap between two members that are subject to seal bonding, it is necessary to perform precise control of the local heating conditions, and often poor seal bonding results. Moreover, the inventors of the present invention have contemplated adopting a construction in which a seal bonding material that has been melted or softened to allow seal bonding is successively supplied to the bonding position. However, it was found that, when melted or softened seal bonding material is to be successively supplied to the gap between two members, it is necessary to attain a fluidity sufficient to allow the seal bonding material to be filled in the gap while achieving a sufficient contact between the seal bonding material and each of the upper and lower surfaces of the gap, and hence an extremely precise control of relevant conditions becomes necessary. Hereinbelow, a description will be given of specific constructions which the inventors of the present invention have found with a view to alleviating the above-mentioned problems that result from attempting to arrange mainly a seal bonding material in the gap between two members.

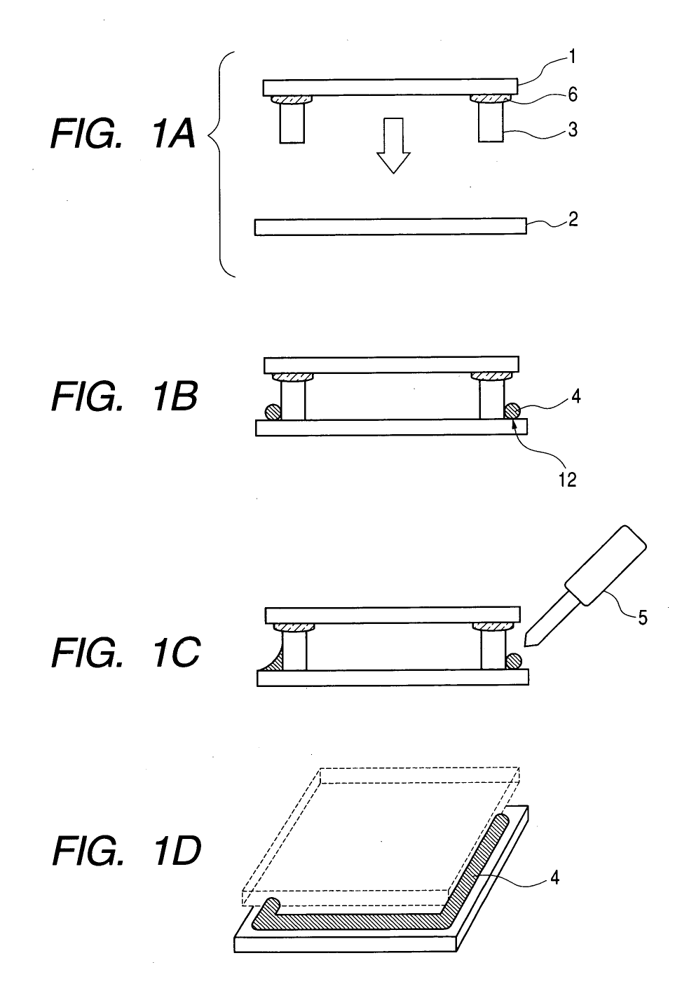

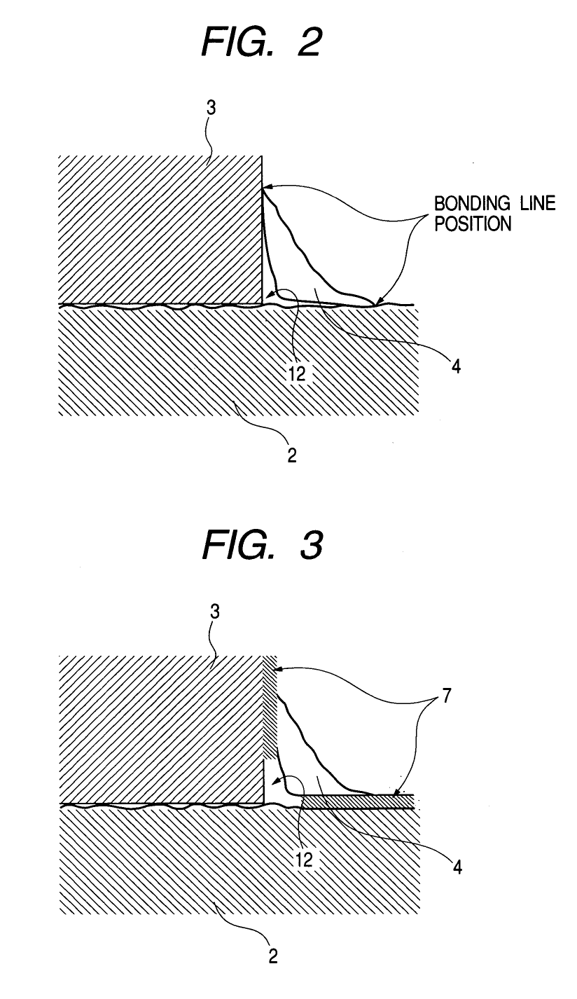

FIGS. 1A to 1D are explanatory diagrams showing a manufacturing method for an airtight container according to an embodiment mode of the present invention. In this embodiment mode, a series of steps described below are conducted within a vacuum chamber set to a vacuum atmosphere of 1×10⁻⁵ Pa or lower, for example.

(Assembling Step)

FIG. 1A shows an assembling step, in which a member used to define an airtight space together with a substrate is abutted on the substrate under a vacuum atmosphere to form a corner portion 12. In this embodiment mode, the substrate is a rear plate 2 constituting an image forming apparatus, and the member for defining the airtight space together with the rear plate 2 is a glass outer frame 3 fixed to a face plate 1 constituting the image forming apparatus. That is, the rear plate 2 and the face plate 1 are a pair of substrates that are opposed to each other, and the glass outer frame 3 are bonded and fixed to the face plate 1 in an upright fashion, with an end face of the glass outer frame being abutted on the rear plate 2 to form the corner portion 12.

(Seal Bonding Material Arranging Step)

FIG. 1B shows a seal bonding material arranging step, in which a seal bonding material is arranged in the corner portion 12 that is formed by abutting the end face of the glass outer frame 3 on the rear plate 2.

The corner portion 12 refers to a portion surrounded by two surfaces that are not parallel to each other. In this example, the corner portion 12 refers to a portion formed by abutting the end face of the glass outer frame 3 on the rear plate 2, that is, a corner portion surrounded by a top surface of the rear plate 2 and a side surface of the glass outer frame 3 which is not parallel to the top surface. A corner portion is also formed inside the airtight space defined by the face plate 1, the rear plate 2, and the glass outer frame 3, and thus any of the corner portions may be adopted as a portion where the seal bonding material is arranged. However, for ease of carrying out the bonding step, this embodiment mode adopts a construction in which the seal bonding material is arranged in the corner portion formed outside the airtight space.

As the seal bonding material to be arranged in the corner portion 12, it is preferable to use a low-melting substance. In this embodiment mode, indium (In) as a low-melting metal is adopted. In is a material with a relatively low melting point of 156° C. and little gas emission at the melting point (softening point). Although heating of up to approximately 500° C is required when using a flit glass, heating of up to 200° C. suffices when using In, making it possible to attain an effect of simplifying the manufacturing process. Indium alloy is also known as such low-melting substance in addition to pure indium, and thus indium alloy may also be suitably used.

Instead of performing the series of steps under a vacuum atmosphere, it is also possible to use a method in which a exhaust port (not shown) is attached to a given area of the airtight container to be manufactured and the exhaust port is sealed after producing a vacuum atmosphere by evacuating the interior of the airtight container through the exhaust port. However, In is used as the seal bonding material in this embodiment mode, and since In oxidizes relatively easily in the atmosphere, it is desirable to perform the series of steps under a vacuum atmosphere. This is because a thick surface oxide film is formed when metal In is melted in the atmosphere, and indium oxide is harder than pure indium, so that airtightness may be impaired. Even when using another seal bonding material such as indium alloy or another metal or alloy thereof, the seal bonding material may still be prone to the influence of the atmosphere. Thus, the heating step for effecting the bonding is desirably performed under a vacuum atmosphere.

A metal In 4 molded into a wire rod is used as In, and the In 14 as a solid, linear seal bonding material is arranged around the entire periphery of the corner portion 12 so as to form a loop. That is, the In 4 is arranged so as to form a closed bonding line for defining the airtight space. In performing this step within the vacuum chamber, instead of supplying the molded wire rod to the corner portion 12, it is also possible to apply a melted solution to the corner portion 12 by using a dispenser or the like. The dispenser which is to be used is desirably of the fixed-amount discharging type. It is difficult to achieve a fixed-amount discharge with a generally employed air control dispenser, so that a dispenser having a cylinder or gear type feed mechanism is preferably used. The seal bonding material may also be previously supplied to a portion that becomes the corner portion upon bringing the substrate and the member into abutment against each other.

(Local Heating Step)

FIG. 1C shows a local heating step in which the metal In 4 arranged in the corner portion 12 is locally heated by a local heating means over a small area and melted.

In this embodiment mode, the local heating means used has means for giving vibration to the heated seal bonding material. More specifically, an ultrasonic soldering iron 5 as an ultrasonic soldering means is adopted. By using the ultrasonic soldering iron 5, it is possible to give ultrasonic vibration to a welding portion and to weld In with a strong adhesion force. The local heating means is not limited to the ultrasonic heating means, and may take various types of heating. For example, a photoirradiation means or the like may also be adopted. Examples of such photoirradiation means include, for example, a semiconductor laser. In addition, it is also possible to use a heating means for effecting heating by means of radiation heat or electromagnetic wave.

In this embodiment mode, the seal bonding material arranging step and the local heating step are performed separately, so that the seal bonding material is melted by the local heating means after arranging a linear seal bonding material in the corner portion 12. However, it is also possible to perform the seal bonding material arranging step and the local heating step as one step to attain simplification of the process. That is, the seal bonding material may be melted by the local heating means while being dispensed to the corner portion 12 from a seal bonding material supplying means. For example, there may be conceived of a construction in which the ultrasonic soldering iron is equipped to the triaxial robot for arranging the metal In 4. Alternatively, the local heating means itself may function to supply the seal bonding material, so that the seal bonding material is supplied to the heated portion while being dispensed from the local heating means, thereby arranging the seal bonding material in the corner portion 12. For example, there may be conceived of a construction in which a coating head and a soldering iron head are equipped to the tip end of the triaxial robot and the moving mechanism or the like can be shared between those two heads.

By successively moving the local heating means, the welded portion of the In, which has been melted by the local heating, is successively cooled and starts to solidify. By the time the welding (soldering) of the entire periphery of the above-mentioned corner portion 12 is complete, the solidification of the In is substantially complete. Therefore, it is possible to attain a significant reduction in the requisite cooling time.

As described above, the local heating of the seal bonding material is performed by heating the seal bonding material by moving the local heating means along the outer peripheral portion of the airtight container. In this case, by adopting an apparatus with multiple local heating means, it is possible to perform the local heating step in an even shorter time by performing heating of multiple locations at the same time. Further, by using a heating means that does not require a heating energy source and a heating position to be brought into close proximity with each other, such as a local heating means for effecting heating by irradiation of laser light, it is not necessary to move the local heating means along the location where the bonding line is to be formed and it suffices as long as the laser light irradiation position can be successively changed, thereby simplifying the apparatus construction.

The air container shown in FIG. 1D is completed in the manner as described above, in which the entire periphery of the corner portion 12 defined by the rear plate 2 and the glass outer frame 3 is seal-bonded with the metal In 4.

FIG. 2 is an enlarged schematic drawing showing a condition of the seal bonding portion.

As shown in FIG. 2, even when the end face of the glass outer frame 3 is brought into the closest proximity to the rear plate 2, microscopically speaking, the abutment face is not flat but includes surface irregularities. Therefore, the two members are not exactly in complete contact with each other. The presence of the surface irregularities is presumably attributable to such factors as irregularities caused by electrodes, wiring patterns, etc that are formed on the rear plate 2. The glass outer frame 3 and the rear plate 2 are pressed against each other, each with a small pressure roughly equivalent to its self-weight, and are fixed in place such that their relative positions do not change even before and after heat-melting of the metal In 4.

The metal In 4 having been locally heat-melted by the ultrasonic soldering iron 5 are bonded with each of the rear plate 2 and the glass outer frame 3 in an airtight fashion, not in a location where the rear plate 2 and the glass outer frame 3 are in direct contact with each other but in the vicinity of that location. The collection of the bonded positions constitutes a closed bonding line, thus forming the airtight container. That is, the bonding line is formed along the entire outer periphery of the glass outer frame 3, thus forming a closed loop.

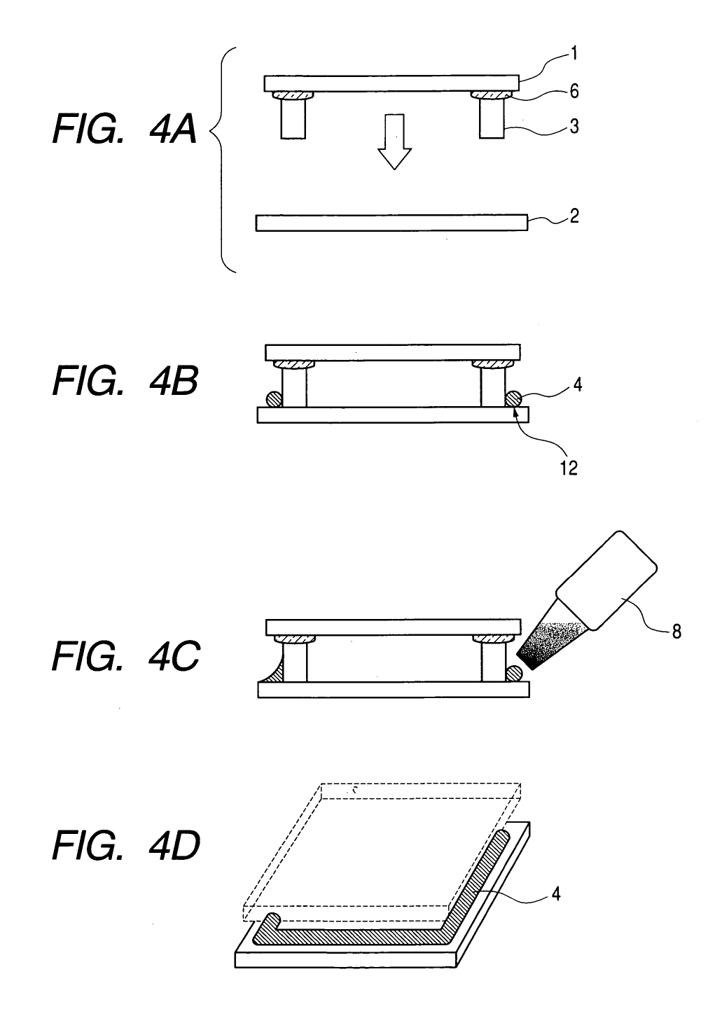

Further, as shown in FIG. 3, a material having a good wettability with the heat-melted seal bonding material may be formed as a base film 7 in the location where the metal In 4 as the seal bonding material is to be arranged. The base film 7 is preferably formed in the respective positions where the metal In 4 is bonded with the rear plate 2 and with the glass outer frame 3.

Used as the material of the base film 7 is a noble metal material that is excellent in terms of solderability and chemically stable, such as Au, Ag, Pt, or the like. The base film 7 is formed at a thickness of several μm. The method of forming the base film 7 is not particularly limited. For example, in addition to using plating, vapor-deposition, or the like, it is also possible to form the base film 7 by printing and backing a paste-like material mixed with a binder.

When forming the base film 7 in the manner as described above, the seal bonding material may be indirectly heat-melted by heating the base film 7. In particular, when using a photoirradiation means such as a semiconductor laser as the local heating means, it is desired to provide the base film because, unlike an ultrasonic heating means, such photoirradiation means generates no ultrasonic vibration.

Further, a construction shown in FIG. 6 is effective for securing sufficient airtightness even when using only a small amount of the metal In 4. That is, as shown in FIG. 6, since the glass outer frame 3 serves a single function of forming the airtight container, the end face of the glass outer frame 3 may be beveled to form a groove portion 13. Also in this case, forming the base film 7 inside the groove portion 13 allows the heat-melted metal In 4 to spread due to its wettability with the base film 7 and enter the gap between the rear plate 2 and the glass outer frame 3, thereby making it possible to secure sufficient airtightness even with a small amount of the metal In 4.

Then, after cooling and solidifying the seal bonding material formed of the metal In 4, the solidified seal bonding material (hereinafter, the seal bonding material solidified by performing the bonding step according to the present invention will be referred to as the “seal bonding member”) may be covered with a reinforcing material. In the case where the seal bonding member has a small thickness, when the obtained airtight container is deformed upon application of stress and subjected to impact as it is moved or dropped, peeling occurs along the bonding line, thus impairing the airtightness. Therefore, in reinforcing the seal bonding material, it is desirable to adopt adhesive that may be functionally insufficient in terms of airtightness but can provide a strong adhesion.

As described above, according to the method of manufacturing the airtight container of this embodiment mode, the pair of mutually opposing substrates are retained while being spaced apart from each other at a predetermined interval, and the seal bonding material for forming the bonding line is locally heated to melt successively for each small region at a time, without changing the relative positions of the two substrates before and after the seal bonding. Accordingly, there is no need to uniformly pressurize the entire substrate or to perform uniform temperature management, thereby making it possible to realize a highly reliable airtight container by an inexpensive method.

Further, as described above, with the method of manufacturing the airtight container of the present invention, airtightness can be secured for the air container even when the rear plate 2 has surface irregularities. Thus, it is effective to use the method for manufacturing an image display apparatus in which a phosphor and an accelerating electrode are formed on the face plate 1 and an electron source is formed on the rear plate 2. Note that a surface conduction electron-emitting device is preferably adopted as the electron source. The present invention may be used for bonding the face plate and the outer frame with each other. Further, in addition to the electron-emitting device, various types of devices may be used as the display device, such as an electroluminescence device.

Embodiments

Hereinbelow, the present invention will be described in more detail by way of embodiments thereof. However, the present invention is not limited to the embodiments described below.

Embodiment 1

A method of manufacturing an airtight container according to Embodiment 1 of the invention will be described with reference to FIGS. 1A through 1D. In this embodiment, a series of steps described below are performed within a vacuum chamber set to a high-vacuum atmosphere of 1×10⁻⁵ or less.

(Step 1A)

FIG. 1A shows an assembling step. The face plate 1 and the rear plate 2 are a pair of mutually opposing substrates. In this embodiment, the face plate 1 is a glass substrate on which a phosphor and an accelerating electrode for accelerating electrons emitted from an electron source are formed, and the rear plate 2 is an electron-source substrate. The height of the glass outer frame 3 arranged between those substrates 1 and 2 defines a gap between the two substrates.

First, using a flit glass 6, the glass outer frame 3 is bonded and fixed to the face plate 1 in an upright fashion, with an end face of the glass outer frame 3 being abutted on the rear plate 2 to form the corner portion 12.

The positional alignment between the face plate 1 and the rear plate 2 is performed with a high accuracy. In the case where the airtight container of this embodiment is used for a color display, plane type image forming apparatus, the positional alignment is effected within an accuracy of approximately 50 μm. As for the fixing pressure to be applied during the assembling step, a weak pressure equivalent to that applied by the self-weights of the face plate 1 and the glass outer frame 3 is sufficient, and no other pressurizing means is required.

According to conventional manufacturing methods, airtightness is secured by the flit glass as a seal bonding material filling in the irregularities of the surface of the glass substrate. Thus, it is necessary to apply a predetermined pressure in a uniform manner. Accordingly, it is necessary to provide a high-accuracy mechanism for applying a uniform pressure and to perform a feedback control on positional displacement accompanying the substrate deformation due to an applied pressure, and thus those conventional methods require a large manufacturing apparatus, leading to an increase in manufacturing cost. However, according to the present invention, there is no need to apply a large pressure, nor it is necessary to give particular consideration to the uniformity of the applied pressure, thus attaining effects such as improved yield, etc.

(Step 1B)

FIG. 1B shows a seal bonding material arranging step. In this embodiment, the metal In 4 is used as the seal bonding material, and the metal In 4 molded into a wire rod is arranged in the corner portion 12 formed by bringing the glass outer frame 3 into abutment on the rear plate 2. In this embodiment, the linear metal In 4 of 1 mmφ is arranged in the corner portion 12 by using the triaxial robot.

(Step 1C)

FIG. 1C shows a local heating step in which local heating is performed within the above-mentioned vacuum chamber. The ultrasonic soldering iron 5 is used as a local heating means. Upon melting the metal In 4 arranged in the corner portion 12 by using the ultrasonic soldering iron 5, in the corner portion 12, the metal In 4 serving as the seal bonding material forms an airtight bond with each of the rear plate and the outer frame. As a result, the rear plate and the outer frame are bonded together through the intermediation of the seal bonding member arranged in the corner portion that is formed by bringing the rear plate and the outer frame into abutment against each other.

As described before, the metal In easily oxidizes in the atmosphere even under the room temperature environment, forming a hard surface oxide film on its linear surface. The In surface oxide film has a high melting point of 800° C. or above, and as it remains as a solid within a liquid In without being melted by heating, the In surface oxide film may form a leak path, which in turn causes a vacuum leak. Therefore, it is desirable to use a heating means with which the surface oxide film can be positively broken. If the In surface oxide film is broken, the liquid In seeps from the inside to form a convection current, and the oxide is subjected to vaporization or the like due to its chemical reaction with pure In, thus reducing the fear of a vacuum leak. In order to break the oxide film and ensure that the metal In 4 is bonded to the rear plate 2 and to the glass surface of the glass outer frame 3 to realize high airtightness, it is desirable to adopt an ultrasonic soldering method. As the ultrasonic soldering iron 5, one with an ultrasonic power of several W at an iron temperature of 200° C. or higher will suffice.

As shown in FIG. 2, in this embodiment, while successively moving the ultrasonic soldering iron 5 as the local heating means for performing local heating along the entire periphery of the corner portion 12, the metal In 4 and the rear plate 2, and also the metal In 4 and the outer frame 3, are welded together at bonding positions in the corner portion 12, forming a bonding line over the entire periphery of the outer frame 3.

In a construction in which heating of the entire periphery is performed at once, rather than a construction in which the bonding line is successively formed for each small region at a time, it is desired to achieve uniform heating state at the same time. More specifically, heating a glass substrate of several tens square cm within a uniformity of plus or minus 4° C. over the entire periphery of the outer frame requires an expensive and large temperature control apparatus, as it is necessary to divide a heater into about 20 parts and individually control each of them. However, in this embodiment, local heating is employed, and the bonding line is successively formed. Thus, it is possible to perform seal bonding without any problem even when there exists a temperature distribution of 10° C. or larger, thereby facilitating the seal bonding operation.

Further, as shown in FIG. 3, in order to enhance the adhesion between the metal In 4 and the glass surface of the glass outer frame 3, it is desirable to form on the glass surface the base film 7 for improving affinity such as wettability. As described above, a noble metal material that is excellent in terms of solderability and chemically stable, such as Au, Ag, or Pt, is used as the material of the base film 7, and the base film 7 is formed at a thickness of several μm. As for the method of forming the base film 7, for example, in addition to using plating, vapor-deposition, or the like, it is also possible to form the base film 7 by printing and baking a paste-like material mixed with a binder.

In accordance with this embodiment, a highly reliable airtight container can be thus manufactured at low cost. The airtight container of this embodiment exhibits an airtightness as expressed by the leak amount of He gas of 1×10⁻¹⁴ Pa·m³/sec. When this airtight container is applied to a plane type image forming apparatus having a surface conduction electron-emitting device, it is possible to obtain a high-reliability, high-quality image display capable of ensuring a service life of more than 10,000 hours.

Embodiment 2

In Embodiment 2 of the invention, a semiconductor laser is used as the local heating means in order to achieve miniaturization of the apparatus. While a method of manufacturing an airtight container according to Embodiment 2 will be described hereinbelow using FIGS. 4A through 4D, steps 4A and 4B are carried out in the same manner as in the steps 1A and 1B in Embodiment 1.

(Step 4C)

FIG. 4C shows a local heating step. In this embodiment, a semiconductor laser 8 with a wavelength of about 800 nm is used as the local heating means. With the semiconductor laser 8, a beam of light with a power of about 10W is condensed by means of a condenser lens into light of 1 mmφ, and then irradiated to the metal In 4. As compared with the case where the ultrasonic soldering iron of Embodiment 1 is used, the local heating means can be miniaturized when utilizing heating effected by beam condensation with the semiconductor laser 8, thereby facilitating the seal bonding operation, particularly when manufacturing a thin airtight container in which the glass outer frame 3 has a height of a little less than 2 mm.

When using a light guide such as an optical fiber as a path leading to the condenser lens, the miniaturization and assembly of the heating means are further facilitated. In addition, other than the semiconductor laser, a xenon lamp or the like may also be used as the photoirradiation means.

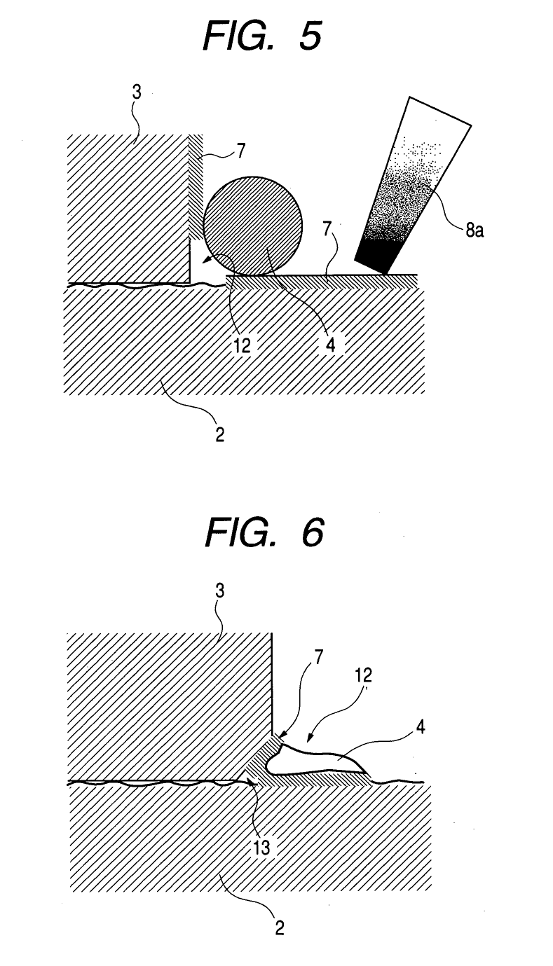

As shown in FIG. 5, according to this embodiment, in locations where the metal In 4 as the seal bonding material is to be arranged, a material having good wettability with the seal bonding material is formed as the base film 7. More specifically, the base film 7 is formed in the bonding positions where the rear plate 2 and the glass outer frame 3 are respectively bonded with the seal bonding material.

By providing the base film 7, the following two effects can be obtained. First, as one effect, in the case of this embodiment which employs the semiconductor laser 8 as the heating means, it is possible to attain a good bond while securing a sufficient wettability with the glass surface unless an assist such as ultrasonic vibration is provided.

As another effect, the metal In 4 as the seal bonding material having a metallic luster is employed, and hence a reduction in heating efficiency due to reflection of light by the seal bonding material is at least partially compensated for by heat generation due to light absorption by the base film. As shown in FIG. 5, in order to obtain this effect in a more favorable manner, it is desired to heat the metal In 4 indirectly by irradiating a laser beam 8a to the base film 7, rather than irradiating light directly to the metal In 4. As the base film 7, use of a silver paste, which is used for the wire material of an electron-emitting device, is particularly effective because a film having irregularities on its surface can be attained to provide a metal film having no metallic luster, making it possible to achieve an energy absorptance exceeding 50%.

Further, as shown in FIG. 6, in order to secure airtightness even with a small amount of the metal In 4, it is desired that the end face of the glass outer frame 3 be beveled to form the groove portion 13. Also in this case, forming the base film 7 inside the groove portion 13 allows the heat-melted metal In 4 to spread due to its wettability with the base film 7 and enter the gap between the rear plate 2 and the glass outer frame 3, which is the groove portion 13, thereby making it possible to secure sufficient airtightness even with the small amount of the metal In 4.

Embodiment 3

Since a low-melting metal such as the metal In 4 is an expensive material, it is desired to reduce the usage amount of the seal bonding material as much as possible.

However, when seal bonding is effected by using a small amount of the seal bonding material, the obtained bonded area is reduced and the bonding strength decreases as a result. Thus, to compensate for decreases in the reliability as an airtight container, some contrivances may be made to enhance the bonding strength between the metal In 4 and the glass outer frame 3, or a seal bonding reinforcing step may be carried out after the local heating step.

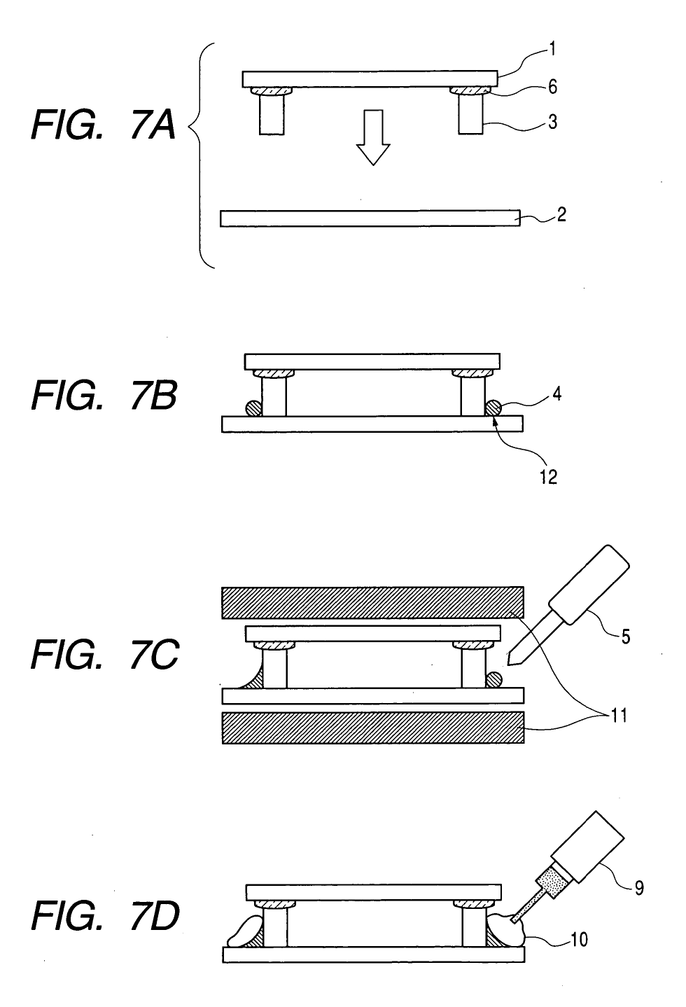

Hereinbelow, while a method of manufacturing an airtight container according to Embodiment 3 will be described using FIGS. 7A through 7D, steps 7A and 7B are carried out in the same manner as in the steps 1A and 1B in Embodiment 1.

(Step 7C)

FIG. 7C shows a local heating step. In this embodiment, the glass outer frame 3 is subjected to assist-heating in order to enhance the adhesion force acting between the melted metal In 4 and the outer glass frame 3. Assist-heating refers to a type of heating such that the seal bonding material is not heated to a degree sufficient for effecting seal bonding by this assist-heating alone. To perform the assist-heating, the face plate 1 and the rear plate 2 are sandwiched by hot plates 11, 11 from their respective outer surfaces. Upon performing this assist-heating, the local heating of the metal In 4 is further performed.

The oxidation reaction of the metal In 4 is liable to proceed at a temperature of 130° C. or higher. Thus, the entire airtight container is heated to about 100° C. Such simple heating means suffices because a sufficient wettability can be secured only by heating of up to about 90 to 110° C. and there is no difference in wettability even if a temperature distribution of 10° C. or more is locally present.

(Step 7D)

Step 7D is a reinforcing step. By additionally providing this step, it is possible to reinforce the welding portion (seal bonding portion). In step 7C, although airtightness can be secured with a small amount of the metal In 4, when the obtained airtight container is deformed upon application of stress and subjected to impact as it is moved or dropped, peeling occurs along the bonding line, thus impairing the airtightness. Therefore, in reinforcing the seal bonding material, it is desirable to use an adhesive 10 that may be functionally insufficient in terms of airtightness but can provide a strong adhesion.

As shown in FIGS. 7A through 7D, using a syringe type dispenser 9 or the like, adhesives are applied so as to be over-coated on the melted metal In 4 and then cured. In the case where the reinforcing step is performed within a vacuum chamber, a constraint is imposed to use the adhesive 10 with little emission gas. However, even in the case where the reinforcing step is performed in the atmosphere after taking out the container after bonding is effected with the metal In 4, a vacuum is maintained in the interior of the container due to the airtightness secured by surfaces bonded with the metal In 4. Hence, even organic adhesives involving a large amount of emission gas suffice. In this case, it is desired that, when taking out the container from the vacuum chamber into the atmosphere, careful attention be paid so that no stress will be exerted on the bonded surfaces due to warping etc of the plane type airtight container.

Embodiment 4

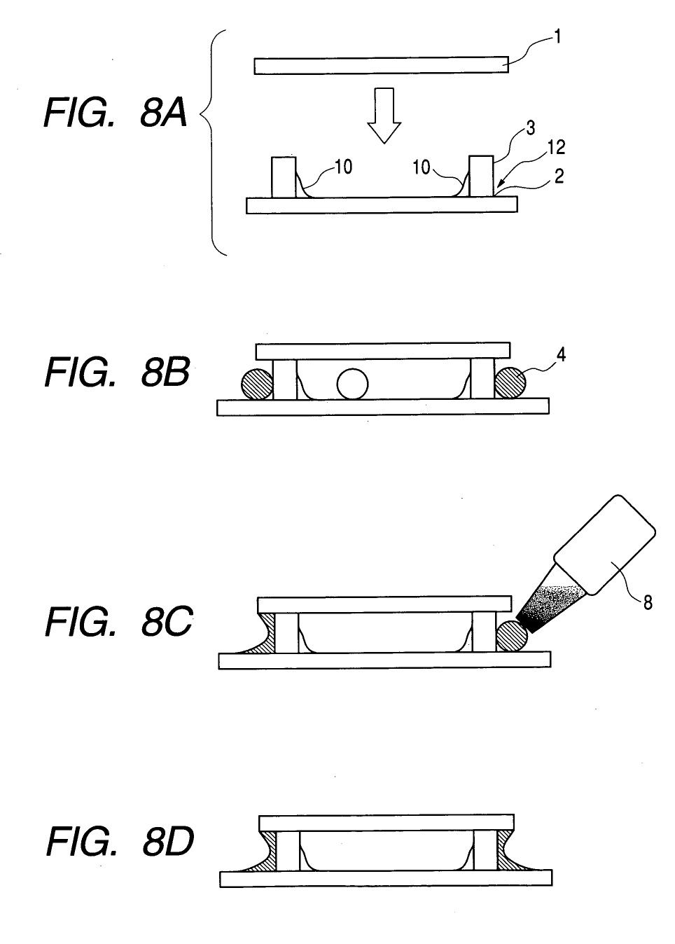

Next, a method of manufacturing an airtight container according to Embodiment 4 of the present invention will be described using FIGS. 8A through 8D. In this embodiment, seal bonding between the face plate 1 and the glass outer frame 3, and sealing-bonding between the rear plate 2 and the glass outer frame 3 are both performed.

(Step 8A)

FIG. 8A shows an assembly step. The glass outer frame 3 is fixed upright on the rear plate 2 in advance by using the adhesive 10. Since the adhesive 10 will remain in the interior of the airtight container, one generating little emission gas after curing is selected as the adhesive 10 and used in as small amount as possible. Since the adhesive 10 does not serve to secure airtightness for the rear plate 2, fixation by means of point attachment suffices as far as a strength sufficient for temporary assembly can be attained.

The assembly and fixation of the face plate 1 and the rear plate 2 are performed after they are subjected to positional alignment with high accuracy.

(Step 8B)

FIG. 8B shows a sealant arranging step. In the same manner as in Embodiment 1, the metal In 4 molded into a wire rod is used as the sealant and arranged in the corner portion 12 formed between the rear plate 2 and the glass outer frame 3. In this step, the linear metal In 4 is arranged in advance in an amount sufficient for surrounding the entire outer peripheral portion of the glass outer frame 3.

(Step 8C)

FIG. 8C shows a local heating step. In this embodiment, the semiconductor laser 8 is used as the local heating means to melt the metal In 4 arranged in the corner portion 12 between the rear plate 2 and the glass outer frame 3.

(Step 8D)

FIG. 8D shows a cooling state. Since local heating is adopted in the present invention, the welding portion (seal bonding portion) is successively cooled as the local heating means is moved, and thus a seal bonding member extending from the rear plate 2 to the face plate 1 so as to cover the entire glass outer frame 3 is formed in a short cooling time. The seal bonding member forms an airtight bond with each of the glass outer frame 3, the rear plate 2, and the face plate 1.

In this embodiment, the metal In 4 is arranged in the corner portion 12 as an outside corner portion after fixation of an inside corner portion between the rear plate 2 and the glass outer frame 3 with the adhesive 10. However, the above order may be reversed. That is, the inside corner portion may be fixed in position with the adhesive 10 after arranging the metal In 4 in the corner portion 12 between the glass outer frame 3 and the rear plate 2, before arranging the face plate 1 onto the glass outer frame 3. The order of steps according to this embodiment allows the metal In 4 to be handled while manipulating the glass outer frame 3 at the same time, thus providing an advantage of facilitating function management of the manufacturing process.

This embodiment is particularly effective for performing seal bonding of a thin airtight container in which the glass outer frame 3 has a relatively small height of, for example, about 1 mm or less. This is because an increase in the usage amount of the metal In 4 according to this embodiment is traded off by the cost reduction effect accompanying the simplification of the manufacturing process.

Embodiment 5

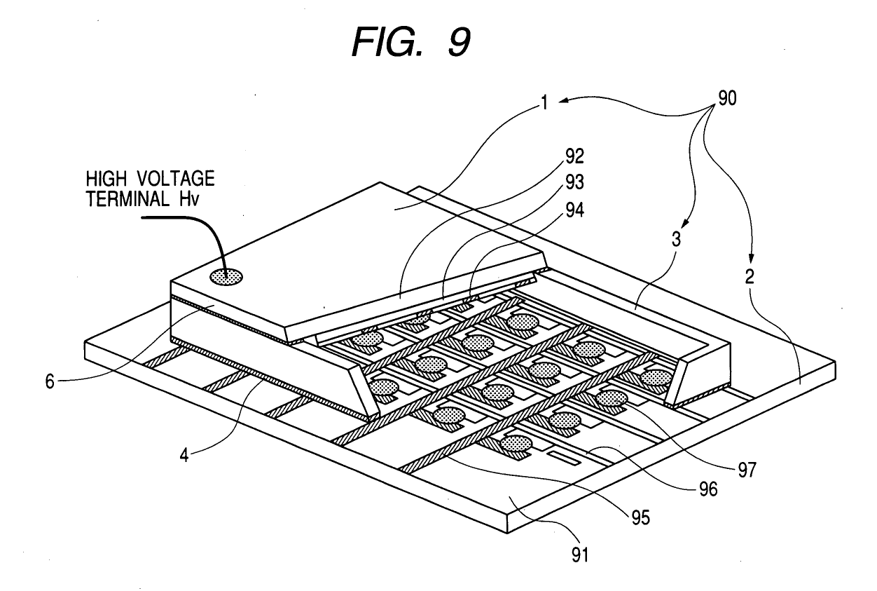

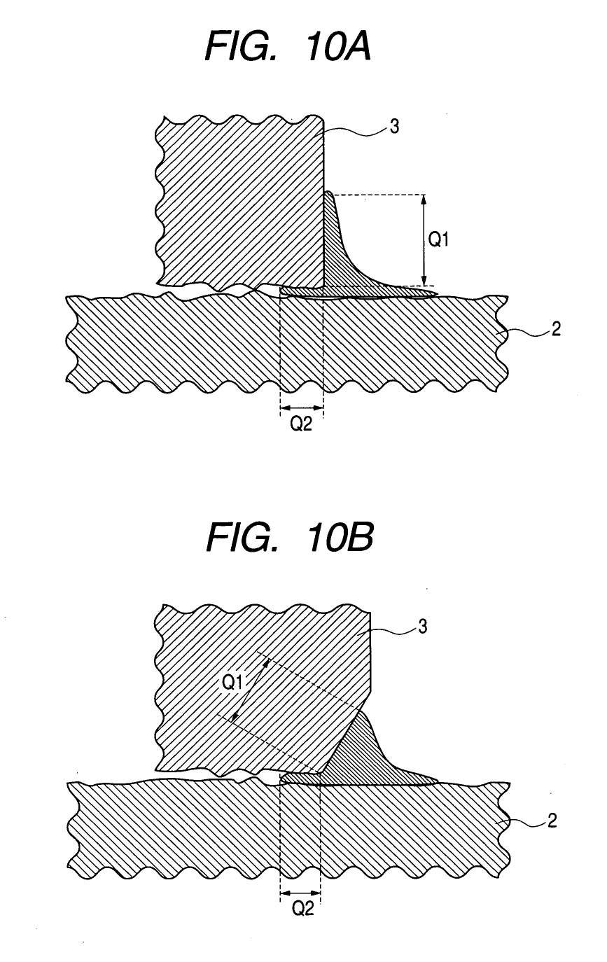

FIG. 9 shows an example of an image display apparatus according to the present invention. Wiring electrodes are formed in matrix on the surface of the rear plate 2, and an electron-emitting device 97 is provided to each pixel. The glass outer frame 3 and the face plate 1 are bonded to each other by means of the flit glass 6, and the glass outer frame 3 and the rear plate 2 are bonded to each other in the corner portion by means of metal In.

As described above, according to the method of manufacturing the airtight container or the image display apparatus according to the present invention, seal bonding is effected by using the corner portion. As a result, the seal bonding operation can be performed with good yield, and an airtight container or image display apparatus with high reliability can be manufactured at low cost.

What is claimed is:

1. A method of manufacturing an airtight container, comprising the steps of:
setting a member for defining an airtight space together with a substrate to abut on the substrate
supplying a seal bonding material to a corner portion formed by the substrate and the member or a portion to be the corner portion formed in the setting step; and
after the step of setting the member to abut on the substrate, forming a closed bonding line by performing airtight bonding of each of the substrate and the member with the seal bonding material by locally heating the seal bonding material to a temperature equal to or higher than a temperature that allows the airtight bonding and then curing the seal bonding material.

2. A method of manufacturing an airtight container according to claim 1, wherein the step of forming the closed bonding line comprises performing the airtight bonding of each of the substrate and the member with the seal bonding material for each small region at a time.

3. A method of manufacturing an airtight container according to claim 1, wherein the substrate is one substrate of a pair of mutually opposing substrates, and the member is a frame fixed to the other substrate.

4. A method of manufacturing an airtight container according to claim 1, wherein the step of forming the closed bonding line is performed under a vacuum atmosphere.

5. A method of manufacturing an airtight container according to claim 1, wherein photoirradiation is used in performing the local heating.

6. A method of manufacturing an airtight container according to claim 1, wherein the seal bonding material is a low-melting point substance.

7. A method of manufacturing an airtight container according to claim 1, wherein the corner portion comprises a groove portion formed therein in the state where the setting step is performed.

8. A method of manufacturing an airtight container according to claim 1, further comprising forming a base film in a location where the seal bonding material is to be arranged, the base film being formed of a material having a good wettability with the seal bonding material.

9. A method of manufacturing an airtight container according to claim 8, further comprising heat-melting the seal bonding material indirectly by heating the base film.

10. A method of manufacturing an airtight container according to claim 1, wherein the seal bonding material which is supplied in the supplying step, in the corner portion or the portion to be the corner portion, is molded into a solid state.

11. A method of manufacturing an airtight container according to claim 1, wherein when the seal bonding member, which is obtained as the seal bonding material solidifies at a predetermined position of the bonding line, is seen in cross section taken along a direction perpendicular to a longitudinal direction of the bonding line, in the corner portion formed by the substrate and the above-mentioned member, a penetration length of the seal bonding member penetrating between mutually opposed surfaces of the substrate and the above-mentioned member is shorter than a contact length over which the seal bonding member contacts the member.

12. A method of manufacturing an airtight container, comprising the steps of:
setting a member for defining an airtight space together with a substrate to abut on the substrate; and
after the step of setting the member to abut on the member, forming a closed bonding line by performing airtight bonding of each of the substrate and the member with a seal bonding material by supplying, to a corner portion formed by the substrate and the member, the seal bonding material that is heated to a temperature equal to or higher than a temperature that allows the airtight bonding and then curing the seal bonding material.

13. A method of manufacturing an airtight container according to claim 12, wherein the step of forming the closed bonding line comprises performing the airtight bonding of each of the substrate and the member with the seal bonding material for each small region at a time.

14. A method of manufacturing an airtight container according to claim 12, wherein the substrate is one substrate of a pair of mutually opposing substrates, and the member is a frame fixed to the other substrate.

15. A method of manufacturing an airtight container according to claim 12, wherein the step of forming the closed bonding line is performed under a vacuum atmosphere.

16. A method of manufacturing an airtight container according to claim 12, wherein the corner portion comprises a groove portion formed therein in the state where the setting step is performed.

17. A method of manufacturing an airtight container according to claim 12, further comprising forming a base film in a location where the seal bonding material is to be arranged, the base film being formed of a material having a good wettability with the seal bonding material.

18. A method of manufacturing an airtight container according to claim 12, wherein when the seal bonding member, which is obtained as the seal bonding material solidifies at a predetermined position of the bonding line, is seen in cross section taken along a direction perpendicular to a longitudinal direction of the bonding line, in the corner portion defined by the substrate and the above-mentioned member, a penetration length of the seal bonding member penetrating between mutually opposed surfaces of the substrate and the above-mentioned member is shorter than a contact length over which the seal bonding member contacts the member set to abut on the substrate.

19. A method of manufacturing an image display apparatus, comprising forming an airtight container for containing display devices by using the method of manufacturing an airtight container as set forth in claim 1.

20. A method of manufacturing an image display apparatus, comprising forming an airtight container for containing display devices by using the method of manufacturing an airtight container as set forth in claim 12.
